(19) United States
(12) Patent Application Publication
(10) Pub. No.: US 2025/0137143 A1
(43) Pub. Date: May 1, 2025

(54) NON-PHOSPHATE CORROSION INHIBITION COMPOSITIONS AND METHODS FOR MITIGATING CORROSION IN COOLING WATER APPLICATIONS

(71) Applicant: ECOLAB USA Inc., St. Paul, MN (US)

(72) Inventors: Bingzhi CHEN, Naperville, IL (US); Mo LI, Naperville, IL (US); Malgorzata Anna KRAWCZYK, Chicago, IL (US); Xuejun WANG, Naperville, IL (US); Xiaojin Harry LI, Bartlett, IL (US)

(73) Assignee: ECOLAB USA Inc., St. Paul, MN (US)

(21) Appl. No.: 18/927,640

(22) Filed: Oct. 25, 2024

Related U.S. Application Data
(60) Provisional application No. 63/593,396, filed on Oct. 26, 2023.

(51) Int. Cl. C23F 11/18; C23F 11/12

(52) U.S. Cl. CPC C23F 11/187; C23F 11/124

(57) ABSTRACT

Compositions and methods for inhibiting the corrosion of metals in contact with an aqueous system are provided. For example, the corrosion inhibitor composition of the present embodiments can include an oxyanion of an amphoteric material, a silicate, and an additional component. The corrosion inhibitor can be substantially phosphate free or free of phosphorus. The additional component can include, for example, a hydroxycarboxylic acid.

### TECHNICAL FIELD

The present disclosure generally relates to compositions and methods for controlling corrosion in aqueous systems. More particularly, the disclosure relates to compositions comprising oxyanions of amphoteric metals and the use thereof for inhibiting corrosion.

### BACKGROUND

Corrosion of metal surfaces in aqueous media has long been a problem for numerous industries, such as oil and gas, food and beverage, and washing/sanitizing, among others. For example, during the production of oil and gas, several corrosive components are present, such as brines, organic acids, carbon dioxide, hydrogen sulfide, and microorganisms. These aggressive constituents can cause severe corrosion as evidenced by surface pitting, embrittlement, and general loss of metal. The metallic surfaces can be composed of high alloy steels, including chrome steels, ferritic alloy steels, austenitic stainless steels, precipitation-hardened stainless steels, and high nickel content steels, but most often the less expensive carbon steels are utilized in combination with corrosion inhibitors or coatings. This problem is even more troublesome in deep-sea operations where replacement of corroded equipment is difficult and costly.

Inexpensive inorganic phosphates are often used in cooling water treatment programs. This includes the use of orthophosphates as anionic corrosion inhibitors and complex phosphates as cathodic inhibitors. Orthophosphates, when used, are often supplied in the form of phosphoric acid or one of its sodium or potassium salts.

Use of phosphates in these water treatment programs has several shortcomings. For example, phosphates can provide nutrients in microbiological growth, such as cyanobacteria and algae, which can have a significant impact on downstream ecosystems. Excessive biomass growth due to phosphorus nutrients in lakes and rivers can cause reduced light penetration, organic growth degradation, and subsequent depletion of oxygen in the water. To help counteract these issues, regional and national governments have promulgated increasingly strict phosphorus discharge restrictions.

Accordingly, with industries showing increasing interests in water treatment programs that do not rely on phosphate, methods and compositions for corrosion control chemistries for use in water treatment with alternate chemistries are desired.

### BRIEF SUMMARY

The present disclosure provides methods and compositions for inhibiting corrosion. In some embodiments, the disclosure provides a method of inhibiting corrosion of a metal surface in contact with a medium. The method comprises adding a composition to the medium, wherein the composition comprises an oxyanion of an amphoteric metal.

The amphoteric metal may be selected from the group consisting of zinc, aluminum, tin, iron, titanium, zirconium, copper, and any combination thereof.

The oxyanion of the amphoteric metal may be selected from the group consisting of sodium zincate, sodium stannite, sodium stannate, sodium aluminate, sodium titanate, sodium titanite, sodium zirconate, sodium cuprate, sodium ferrite, sodium ferrate, potassium zincate, potassium stannite, potassium stannate, potassium aluminate, potassium titanate, potassium titanite, potassium zirconate, potassium cuprate, potassium ferrite, potassium ferrate, lithium zincate, lithium stannite, lithium stannate, lithium aluminate, lithium titanate, lithium titanite, lithium zirconate, lithium cuprate, lithium ferrite, lithium ferrate, and any combination thereof.

The method may further comprise adding a silicate, a silica, or a combination thereof to the medium. The silicate, the silica, and/or the combination thereof may be added before, after, and/or with the oxyanion of the amphoteric metal.

In some embodiments, the oxyanion of the amphoteric metal and the silicate, the silica, and/or the combination thereof are premixed before being added to the medium.

In some embodiments, the method may further comprise reacting the silicate, the silica, and/or the combination thereof with the oxyanion of the amphoteric metal and forming an oxyanion of an amphoteric metal silicate.

The oxyanion of the amphoteric metal silicate may be selected from the group consisting of a sodium aluminosilicate salt, a sodium zincnosilicate salt, a sodium stannasilicate salt, a sodium stannisilicate salt, a sodium titanisilicate salt, a sodium titanosilicate salt, a sodium zirconosilicate salt, a sodium cuprate silicate salt, a sodium ferrisilicate salt, a sodium ferrasilicate salt, a potassium aluminosilicate salt, a potassium zincnosilicate salt, a potassium stannasilicate salt, a potassium stannisilicate salt, a potassium titanisilicate salt, a potassium titanosilicate salt, a potassium zirconosilicate salt, a potassium cuprate silicate salt, a potassium ferrisilicate salt, a potassium ferrasilicate salt, a lithium aluminosilicate salt, a lithium zincnosilicate salt, a lithium stannasilicate salt, a lithium stannisilicate salt, a lithium titanisilicate salt, a lithium titanosilicate salt, a lithium zirconosilicate salt, a lithium cuprate silicate salt, a lithium ferrisilicate salt, a lithium ferrasilicate salt, and any combination thereof.

The method may comprise adding from about 0.1 ppm to about 400 ppm of the oxyanion of the amphoteric metal to the medium. The method may comprise adding from about 0.1 ppm to about 200 ppm of the silicate, the silica, or the combination thereof to the medium. The method may further comprise adding from about 0.1 ppm to about 400 ppm of the oxyanion of the amphoteric metal silicate to the medium.

In some embodiments, the method further comprises adding an additional component to the medium, wherein the additional component is selected from the group consisting of a fouling control agent, an additional corrosion inhibitor, a biocide, a preservative, an acid, a hydrogen sulfide scavenger, a surfactant, a scale inhibitor, a pH modifier, a coagulant/flocculant agent, a water clarifier, a dispersing agent, an antioxidant, a polymer degradation prevention agent, a permeability modifier, a CO₂ scavenger, an O₂ scavenger, a gelling agent, a lubricant, a friction reducing agent, a salt, a stabilizer, a yellow metal corrosion inhibitor, and any combination thereof.

The stabilizer may comprise, for example, a hydroxycarboxylic acid, such as lactic acid, citric acid, saccharic acid, tartaric acid, and any combination thereof.

In some embodiments, the stabilizer includes a dispersant comprising a copolymer including at least one monomeric component selected from the group consisting of acrylamidomethanesulfonic acid, dimethyl-2-oxobut-3-en-1-yl-ammonio-methanesulfonate, allyloxypolyethoxy(10) sulfonic acid, 2-acrylamido-2-methylpropane sulfonic acid (i.e., 2-acrylamido-2-methyl-1-propanesulfonic acid or AMPS), 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, a salt of any of the foregoing, and any combination thereof.

The stabilizer may include a polyol selected from the group consisting of a polyglycerol; a branched polyglycerol; a cyclic polyglycerol; a hyperbranched polyglycerol; a polypropylene glycol; a pentaerythritol ethoxylate; a carboxymethylated polyglycerol, polypropylene glycol, pentaerythritol ethoxylate, and sorbitol; a hydroxycarboxalkylated polyglycerol, polypropylene glycol, pentaerythritol ethoxylate, and sorbitol; and a hydroxysulfoalkylated polyglycerol, polypropylene glycol, pentaerythritol ethoxylate, and sorbitol.

In some embodiments, the stabilizer includes a chelant selected from the group consisting of ethylenediamine tetra acetic acid, nitrilotriacetic acid, a polymer comprising maleic acid, a polymer comprising acrylic acid, and any combination thereof.

The scale inhibitor may be selected from the group consisting of a polyacrylate, a polymaleic anhydride, an alkyl epoxy carboxylate, a polyepoxy succinic acid, polyaspartic acid, a polyacrylamide copolymer, an acrylic acid and hydroxypropylacrylate copolymer, and any combination thereof.

The yellow metal corrosion inhibitor may be an azole-based corrosion inhibitor selected from the group consisting of benzotriazole, tolyltriazole, 5-methylbenzotriazole, 4-methylbenzotriazole, butylbenzotriazole, pentoxybenzotriazole, carboxylbenzotriazole, tetrahydrotolyltriazole, chlorobenzotriazole, chlorotolyltriazole, benzimidazole, a salt of any of the foregoing, and any combination thereof.

The preservative may comprise sodium benzoate, benzoic acid, a nitrite, a sulfite, sodium sorbate, potassium sorbate, or any combination thereof.

In some embodiments, an amount of the stabilizer added to the medium is from about 0.1 ppm to about 200 ppm.

In certain embodiments, the additional component is added to the medium before, after, and/or simultaneously with the oxyanion of the amphoteric metal or the oxyanion of the amphoteric metal silicate, optionally further comprising adding from about 0.1 ppm to about 5,000 ppm of the additional component to the medium.

In some embodiments, the method excludes adding a phosphate to the medium.

In some embodiments, the metal surface comprises steel, copper, cupronickel, brass, or any combination thereof.

In certain embodiments, the composition comprises from about 0.01 wt. % to about 99 wt. % of the oxyanion of the amphoteric metal, from about 0.1 wt. % to about 30 wt. % of the silicate, and from about 0.1 wt. % to about 50 wt. % of the additional component. In certain embodiments, from about 0.1 ppm to about 10,000 ppm of the composition is added to the medium.

The medium may comprise, for example, a corrodent selected from the group consisting of carbon dioxide, oxygen, sodium chloride, calcium chloride, sodium sulfate, magnesium sulfate, and any combination thereof. The medium may comprise cooling water, hot loop water, a glycol water mixture, a brine, or any mixture thereof.

The present disclosure also provides compositions for inhibiting corrosion. In some embodiments, a composition comprises a zincate, a stannite, a stannate, or any combination thereof; a silicate; and a hydroxycarboxylic acid.

The composition may comprise, for example, from about 0.01 wt. % to about 99 wt. % of the zincate, stannite, stannate, or combination thereof; from about 0.1 wt. % to about 30 wt. % of the silicate; and from about 0 wt. % to about 50 wt. % of the hydroxycarboxylic acid.

The composition may comprise sodium stannite, sodium silicate, and saccharic acid.

The composition may optionally comprise a solvent.

In certain embodiments, the composition comprises a pH of about 6 to about 14.

In certain embodiments, the composition excludes phosphorous.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawing in which:

FIG. 1 shows corrosion rate data from a pilot cooling tower test using the combination of stannisilicate and saccharic acid.

### DETAILED DESCRIPTION

Various embodiments and elements thereof are described below. The relationship and functioning of the various elements of the embodiments may be better understood by reference to the following detailed description. However, embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom can be replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The terms “weight percent,” “wt. %,” and variations thereof refer to the concentration of a substance as the weight of that substance divided by the total weight of a composition comprising that substance and multiplied by 100.

The term “corrosion fouling” refers to fouling of a surface, such as a metallic surface (e.g., a heat exchange surface), by corrosion-formed deposits, which may be formed in situ or by breakage and re-deposition from elsewhere in the system.

As used herein, “corrosion inhibitor” is intended to refer to at least one of, or any combination of, the disclosed corrosion inhibitor compounds, corrosion inhibitor intermediates, and corrosion inhibitor product formulations.

In some embodiments, a corrosion inhibitor composition of the present disclosure can include multiple components. For example, the corrosion inhibitor can include a mixture of any oxyanion, a silicate, and/or a salt thereof. Further, the compositions disclosed herein may include one or more additional corrosion inhibitors, such as alkyl, hydroxyalkyl, alkylaryl, arylalkyl or arylamine quaternary salts; mono or polycyclic aromatic amine salts; imidazoline derivatives; mono-, di- or trialkyl or alkyl phosphate esters; phosphate esters of hydroxylamines; phosphate esters of polyols; monomeric or oligomeric fatty acids; and any combination thereof.

The present disclosure generally relates to corrosion inhibitor compositions that are used to inhibit the formation of scale and corrosion deposits in various metal surfaces. At least one aspect of the present disclosure includes a composition comprising an oxyanion of an amphoteric metal. Specifically, the compositions of the present disclosure may include an oxyanion of an amphoteric metal, e.g., zinc, aluminum, tin, and others discussed below, that can inhibit corrosion of metallic surfaces, such as surfaces comprising steel (e.g., mild steel). Amphoteric metal salts have conventionally been unable to be formulated together with silica compounds due to instability issues. Reaction and formation of these oxyanions with silicates to form oxyanionsilicates that provide exceptional corrosion control for metallic surfaces are provided to remedy these instabilities, as well as provide compositions that inhibit corrosion in non-phosphate water treatment programs.

Illustrative, non-limiting examples of the amphoteric metal include zinc, aluminum, tin, iron, titanium, zirconium, copper, and any combination thereof. These amphoteric metals can form oxyanions under high pH conditions. The metal may comprise, for example, tin(II), tin(iv), copper(II), zinc(II), or any combination thereof.

Such chemistries can be used as corrosion inhibitors and perform exceedingly well in corrosion control of metal surfaces, e.g., mild steel, as discussed herein. In some embodiments, the performance can be further enhanced by adding a silica, a silicate, and/or a hydroxycarboxylic acid, such as lactic acid, citric acid, saccharic acid and/or tartaric acid.

In some embodiments, the oxyanion of the amphoteric metal of the present disclosure can be an oxyanion salt. For example, the oxyanion can include one or more of a zincate, such as sodium zincate, a stannite, such as sodium stannite, a stannate, such as sodium stannate, and/or sodium aluminate, sodium titanate, sodium titanite, sodium zirconate, sodium cuprate, sodium ferrite, sodium ferrate, potassium zincate, potassium stannite, potassium stannate, potassium aluminate, potassium titanate, potassium titanite, potassium zirconate, potassium cuprate, potassium ferrite, potassium ferrate, lithium zincate, lithium stannite, lithium stannate, lithium aluminate, lithium titanate, lithium titanite, lithium zirconate, lithium cuprate, lithium ferrite, lithium ferrate, and any combination thereof.

The corrosion inhibitor composition may comprise, for example, from about 0.01 wt. % to about 99 wt. % of the oxyanion of the amphoteric metal, such as from about 0.01 wt. % to about 90 wt. %, about 0.01 wt. % to about 80 wt. %, about 0.01 wt. % to about 70 wt. %, about 0.01 wt. % to about 60 wt. %, about 0.01 wt. % to about 50 wt. %, about 0.1 wt. % to about 50 wt. %, about 0.1 wt. % to about 60 wt. %, about 0.1 wt. % to about 70 wt. %, about 0.1 wt. % to about 80 wt. %, about 0.1 wt. % to about 90 wt. %, about 1 wt. % to about 99 wt. %, about 10 wt. % to about 99 wt. %, about 20 wt. % to about 99 wt. %, about 30 wt. % to about 99 wt. %, about 40 wt. % to about 99 wt. %, or about 50 wt. % to about 99 wt. % based on a total weight of the corrosion inhibitor composition.

The corrosion inhibitor compositions and/or the mediums of the present disclosure can be pH-controlled, e.g., to provide a resultant solution upon dissolution of the water treatment composition having a threshold pH. The pH can be controlled in a variety of ways, such as through the selection and incorporation of one or more acidified and/or alkaline constituent components in the formulated water treatment composition and/or through the incorporation of one or more solid, pH regulating components in the composition that function to modify the pH of the medium and/or resultant solution formed from the solid composition. When used, the one or more solid, pH regulating components, which may exclude phosphorus, may also function as a filler in the composition, e.g., increasing the volume of the water treatment composition in which the active constituent components are dispersed.

In different formulations, a pH regulating component included in the water treatment composition may be an acid, a base, and/or a neutral salt. The selection and relative amount of one or more pH regulating components used in the composition may vary depending on the other specific constituent components included in the composition and the solution pH provided by those other constituent components. Example pH regulating components that may be used include, but are not limited to, alkali hydroxides, alkali carbonates, alkali bicarbonates, alkaline earth metal hydroxides, alkaline earth metal carbonates, alkaline earth metal bicarbonates, alkali sulfates, alkaline earth metal sulfates, alkali bisulfates, alkaline earth metal bisulfates, alkali and/or alkaline earth metal silicates, mineral acids, sulfamic acid, and/or organic acids (e.g., lactic acid, acetic acid, formic acid, citric acid, oxalic acid, uric acid, malic acid, tartaric acid). In some implementations, one or more pH regulating components used in the composition are selected from the group consisting of an alkali sulfates, an alkaline earth metal sulfates, an alkali bisulfates, an alkaline earth metal bisulfates, sulfamic acid, an alkaline earth metal carbonate, citric acid, and combinations thereof.

In certain aspects, a pH of the composition or medium can be about 6 to about 14, about 6.5 to about 14, about 7 to about 14, about 7.5 to about 14, about 8 to about 14, about 8.5 to about 14, about 9 to about 14, about 9.5 to about 14, about 10 to about 14, about 10.5 to about 14, about 11 to about 14, about 11.5 to about 14, about 12 to about 14, about 12.5 to about 14, about 13 to about 14, or about 13.5 to about 14.

In some embodiments, the pH of the resultant composition can range from about 6 to about 14, from about 7 to about 13, from about 8 to about 12, from about 8.5 to about 12, or from about 9 to about 11.

The corrosion inhibitor composition of the present disclosure may optionally include a filler and/or binding agent. Example fillers and/or binding agents that may be used include a hydrated chelating agent, such as a hydrated aminocarboxylate, a hydrated polycarboxylate or hydrated anionic polymer, a hydrated citrate salt or a hydrated tartrate salt, or the like, together with an alkali metal carbonate. Examples of fillers that may be used include sodium sulfate, sodium chloride, a silicate, a silica, a starch, a sugar, C₁-C₁₀ alkylene glycol, such as propylene glycol, and the like. Examples of binding agents that may be used include a carbonate salt, an organic acetate, such as an aminocarboxylate, and the like. In other examples, the composition excludes a separate filler and/or binding agent.

To the extent that a silicate, a silica, or a combination thereof is used, the silicate, silica, or combination thereof can be added before, after, and/or with the oxyanion of the amphoteric metal. In certain aspects, reacting the silicate, the silica, or the combination thereof with the oxyanion can form an oxyanionsilicate salt, as discussed below. In some embodiments, the oxyanion of the amphoteric metal and the silicate can be premixed before being added to the medium.

In certain embodiments, the composition may comprise from about 0 wt. % to about 30 wt. % of the silicate, the silica, or the combination thereof, based on a total weight of the corrosion inhibitor composition. For example, the composition may comprise from about 0 wt. % to about 25 wt. %, about 0 wt. % to about 20 wt. %, about 0 wt. % to about 15 wt. %, about 0 wt. % to about 10 wt. %, about 0 wt. % to about 5 wt. %, about 1 wt. % to about 5 wt. %, about 1 wt. % to about 10 wt. %, about 1 wt. % to about 20 wt. %, about 1 wt. % to about 30 wt. %, about 5 wt. % to about 30 wt. %, about 10 wt. % to about 30 wt. %, or about 20 wt. % to about 30 wt. % of the silicate, the silica, or the combination thereof.

In accordance with certain aspects of the disclosure, the silica and/or the silicate may react with the oxyanion of the amphoteric metal to form an oxyanion of an amphoteric metal silicate or an oxyanionsilicate salt. In such embodiments, non-limiting examples of the amphoteric metal silicate include sodium aluminosilicate salt, sodium zincnosilicate salt, sodium stannasilicate salt, sodium stannisilicate salt, sodium titanisilicate salt, sodium titanosilicate salt, sodium zirconosilicate salt, sodium cuprate silicate salt, sodium ferrisilicate salt, sodium ferrasilicate salt, potassium aluminosilicate salt, potassium zincnosilicate salt, potassium stannasilicate salt, potassium stannisilicate salt, potassium titanisilicate salt, potassium titanosilicate salt, potassium zirconosilicate salt, potassium cuprate silicate salt, potassium ferrisilicate salt, potassium ferrasilicate salt, lithium aluminosilicate salt, lithium zincnosilicate salt, lithium stannasilicate salt, lithium stannisilicate salt, lithium titanisilicate salt, lithium titanosilicate salt, lithium zirconosilicate salt, lithium cuprate silicate salt, lithium ferrisilicate salt, lithium ferrasilicate salt, and any combination thereof.

Various methods for making and/or using the presently disclosed oxyanionsilicate salts exist and fall within the scope of the present disclosure. For example, with respect to stannisilicate salt, in some embodiments, stannous chloride can be added into deionized water (diH₂O). The pH of the mixture can be raised by adding NaOH, and then adding sodium silicate. In some embodiments, addition of the NaOH and the sodium silicate can raise the pH of the final product up to about 12 or more. Performance can be further boosted by using with a hydroxycarboxylic acid, such as saccharic acid and/or other stabilizers for corrosion control, as discussed herein.

In some embodiments of the present disclosure, the corrosion inhibitor composition may include an additional component. The additional component can be added to the medium before, after, and/or simultaneously with the oxyanion of the amphoteric metal or the oxyanion of the amphoteric metal silicate.

In some aspects, the additional component comprises a stabilizer. The stabilizer can include, for example, lactic acid, citric acid, saccharic acid and/or tartaric acid.

In some embodiments, the additional component comprises a hydroxycarboxylic acid, a sulfonated homopolymer, a sulfonated copolymer, a polyol, a polycarboxylic acid, a chelant, or any combination thereof.

In some embodiments, the stabilizer includes a polymer dispersant which is a polymer of at least one monomeric component selected from the group consisting of acrylamidomethanesulfonic acid, dimethyl-2-oxobut-3-en-1-yl-ammonio-methanesulfonate, allyloxypolyethoxy(10) sulfonic acid, 2-acrylamido-2-methylpropane sulfonic acid (i.e., 2-acrylamido-2-methyl-1-propanesulfonic acid or AMPS), 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and any combination thereof.

In some embodiments, the stabilizer includes a polyol selected from the group consisting of a polyglycerol; a branched polyglycerol; a cyclic polyglycerol; a hyperbranched polyglycerol; polypropylene glycol; pentaerythritol ethoxylate; carboxymethylated polyglycerol, polypropylene glycol, pentaerythritol ethoxylate, and sorbitol; hydroxycarboxalkylated polyglycerol, polypropylene glycol, pentaerythritol ethoxylate, and sorbitol; and hydroxysulfoalkylated polyglycerol, polypropylene glycol, pentaerythritol ethoxylate, and sorbitol.

In some embodiments, the chelant is selected from the group consisting of ethylenediamine tetra acetic acid, nitrilotriacetic acid, a polymer comprising maleic acid, a polymer comprising acrylic acid, and any combination thereof.

Illustrative, non-limiting examples of scale inhibitors that can be used in connection with the compositions disclosed herein include one or more of a polyacrylate, a polymaleic anhydride, an alkyl epoxy carboxylate, polyepoxy succinic acid, polyaspartic acid, a polyacrylamide copolymer, an acrylic acid and hydroxypropylacrylate copolymer, and any combination thereof.

In some embodiments, the additional component may include a scale inhibitor, a yellow metal corrosion inhibitor, a preservative, and any combination thereof.

The yellow metal corrosion inhibitor may include, for example, an azole-based corrosion inhibitor, such as benzotriazole, tolyltriazole, 5-methylbenzotriazole, 4-methylbenzotriazole, butylbenzotriazole, pentoxybenzotriazole, carboxylbenzotriazole, tetrahydrotolyltriazole, a halogen resistant azole, such as chlorobenzotriazole or chlorotolyltriazole, a benzoimidazole, a salt of any of the foregoing, and any combination of the foregoing.

In some embodiments, the preservative can include one or more of sodium benzoate, benzoic acid, a nitrite, a sulfite, sodium sorbate, and potassium sorbate.

The polycarboxylic acid disclosed herein may function as a scale inhibitor. It will be appreciated that the polycarboxylic acid component may be a carboxylic acid, as discussed above, or a residue of a molecule having at least two carboxyl moieties, e.g., dicarboxylic acids, tricarboxylic acids, tetracarboxylic acids, etc. In some embodiments, the polycarboxylic acid component is a copolymer. The copolymer may comprise, consist essentially of, or consist of a polymerized residue of two or more monomers. The two or more monomers may include a first monomer comprising, consisting essentially of, or consisting of a carboxylic acid or a residue thereof and a second monomer, which is different than the first monomer. The first monomer may include a carboxylic acid or a residue of a molecule having at least one carboxyl moiety, a salt thereof, or a conjugate base thereof. The carboxylic acid may include a single carboxyl moiety or a plurality of carboxyl moieties (e.g., dicarboxylic acids, such as maleic acid, etc.).

The corrosion inhibitor composition may comprise from about 0 wt. % to about 50 wt. % of the additional component, based on a total weight of the corrosion inhibitor composition. For example, the composition may comprise from about 0 wt. % to about 40 wt. %, about 0 wt. % to about 30 wt. %, about 0 wt. % to about 20 wt. %, about 0 wt. % to about 10 wt. %, about 5 wt. % to about 50 wt. %, about 10 wt. % to about 50 wt. %, about 20 wt. % to about 50 wt. %, about 30 wt. % to about 50 wt. %, or about 40 wt. % to about 50 wt. % of the additional component.

Each of the components included in the corrosion inhibitor composition can be substantially free of phosphates and/or aluminates. As a result, an entirety of the corrosion inhibitor composition may be substantially phosphate and/or aluminate free. The methods of inhibiting corrosion disclosed herein may exclude a step of adding a phosphate and/or an aluminate to the medium. Substantially free or free of phosphate and/or aluminate means no more than a trace amount of phosphorous and/or an aluminate is present in the composition or added in a method step, such as less than about 1 wt. %, less than about 0.75 wt. %, less than about 0.5 wt. %, less than about 0.25 wt. %, less than about 0.1 wt. %, less than about 0.05 wt. %, less than 0.01 wt. %, less than about 0.001 wt %, or about 0 wt. %.

Each of the constituent components of the corrosion inhibitor composition can be provided in any form, such as liquid or solid form, and mixed together. After mixing and formation of the resulting corrosion inhibitor composition, the composition may, in certain aspects, be chemically homogenous throughout. In other words, each portion of the corrosion inhibitor composition may have the same constituent components in substantially the same relative weight percentages as each other portion of the corrosion inhibitor composition.

Additional examples of components that may be present in the corrosion inhibitor compositions include, but are not limited to, a fouling control agent, an additional corrosion inhibitor, a biocide, a preservative, an acid, a hydrogen sulfide scavenger, a surfactant, a scale inhibitor, a pH modifier, a coagulant/flocculant agent, a water clarifier, a dispersant, an antioxidant, a polymer degradation prevention agent, a permeability modifier, a CO₂ scavenger, an O₂ scavenger, a gelling agent, a lubricant, a friction reducing agent, a salt, and any combination thereof.

Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2 bromo-2 nitropropane-3-diol (Bronopol) and 2 2 dibromo-3-nitrilopropionamide (DBNPA)), and sulfur compounds (e.g., isothiazolone, carbamates, and metronidazole). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable surfactants include, but are not limited to, anionic surfactants and nonionic surfactants. Anionic surfactants include, for example, alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono and dialkyl sulfosuccinates and sulfosuccinamates. Nonionic surfactants include, for example, alcohol alkoxylates, alkylphenol alkoxylates, block copolymers of ethylene, propylene and butylene oxides, alkyl dimethyl amine oxides, alkyl-bis(2 hydroxyethyl) amine oxides, alkyl amidopropyl dimethyl amine oxides, alkylamidopropyl-bis(2 hydroxyethyl) amine oxides, alkyl polyglucosides, polyalkoxylated glycerides, sorbitan esters and polyalkoxylated sorbitan esters, and alkoyl polyethylene glycol esters and diesters.

In some embodiments, the corrosion inhibitor composition comprises a solvent. Illustrative, non-limiting examples of solvents include water, acetic acid, butanediol, a C₁-C₆ alkanol, such as methanol or ethanol, a C₁-C₆ alkoxyalkanol, a glycol ether, a hydrocarbon, a ketone, an ether, an alkylene glycol, an amide, a nitrile, a sulfoxide, an ester, an alcohol, and any combination thereof.

The corrosion inhibitor composition may include any amount of solvent (e.g., water), such as from about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 10 wt. % to about 70 wt. %, about 20 wt. % to about 70 wt. %, about 30 wt. % to about 70 wt. %, about 40 wt. % to about 70 wt. %, about 50 wt. % to about 70 wt. %, about 60 wt. % to about 70 wt. %, about 25 wt. % to about 65 wt. %, or about 35 wt. % to about 55 wt. %. In some aspects, the composition comprises about 1 wt. %, about 5 wt. %, about 10 wt. %, about 20 wt. %, about 30 wt. %, about 40 wt. %, about 50 wt. %, about 60 wt. %, or about 70 wt. % of the solvent.

The presently disclosed corrosion inhibitor composition may further comprise a dispersant. The dispersant can be, for example, any polymer, copolymer, terpolymer, etc., comprising acrylic acid and/or acrylamide with sulfonated monomers. An example of such a dispersant is a copolymer of acrylic acid/2-acrylamido-2-methylpropane sulfonic acid (AMPS). Another example of such a dispersant is a copolymer of acrylic acid/acrylamide. An additional example of such a dispersant is a terpolymer of acrylic acid/acrylamide/sulfonated acrylamide. All monomer ratios in each of the presently disclosed copolymers or terpolymers are intended to be covered by the present disclosure. In one aspect, the dispersant is a terpolymer comprising acrylic acid/acrylamide/sulfonated acrylamide in a monomer ratio of about 40/about 20/about 40.

Further, the dispersant may comprise one or more quaternary ammonium compounds, such as benzyl-(C₁₂-C₁₈ linear alkyl)-dimethylammonium chloride. Additional, non-limiting examples include alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, hydrogenated tallow alkyl (2-ethylhyexyl) dimethyl quaternary ammonium methyl sulfate, and any combination thereof.

In some embodiments, the compositions disclosed herein may include one or more surfactants. Suitable surfactants include, but are not limited to, anionic surfactants, cationic surfactants, nonionic surfactants, and combinations thereof.

Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates, and combinations thereof.

Cationic surfactants include alkyl trimethyl quaternary ammonium salts, alkyl dimethyl benzyl quaternary ammonium salts, dialkyl dimethyl quaternary ammonium salts, imidazolinium salts, and combinations thereof.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters, and combinations thereof.

Also included are betaines and sultanes, amphoteric surfactants such as alkyl amphoacetates and amphodiacetates, alkyl amphopropripionates and amphodipropionates, alkyliminodiproprionate, and combinations thereof.

In certain embodiments, the surfactant may be a quaternary ammonium compound, an amine oxide, an ionic or non-ionic surfactant, or any combination thereof.

Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate.

The present disclosure also provides methods of inhibiting corrosion of a metal surface in contact with a medium. The methods comprise adding an effective amount of a composition to the medium, wherein the composition comprises, consists of, or consists essentially of the corrosion inhibitor compounds disclosed herein, such as the oxyanion of the amphoteric metal, optionally combined with any additional component disclosed herein, such as a silicate, a solvent, a hydroxycarboxylic acid, etc. The composition and optional additional component(s) may be added continuously, intermittently, automatically, and/or manually to the medium and/or the metal surface.

The medium may comprise, for example, a liquid, such as an aqueous fluid and/or a hydrocarbon, and/or a gas. In some embodiments, the medium is an aqueous medium, such as produced water, seawater, municipal water, “gray” water, brackish water, fresh water, recycled water, salt water, frac water, surface water, connate, groundwater, wastewater, or any combination of the foregoing. The aqueous medium may be a continuously flowing medium, such as produced water flowing from a subterranean reservoir and into or through a pipe or tank. The aqueous medium may also be, for example, wastewater isolated from a continuous manufacturing process flowing into a wastewater treatment apparatus. In other embodiments, the aqueous medium is a batch, or plug, substantially disposed in a batchwise or static state within a metal containment.

In some embodiments, the medium comprises cooling water, hot loop water, a glycol/water mixture, a brine, or any mixture thereof.

The methods disclosed herein may be carried out in, for example, a cooling water system that supplies water to one or more processes in which thermal energy from a comparatively hot process stream is transferred to a comparatively cool water stream via a divided heat exchange surface. In some implementations, the corrosion inhibitor compositions according to the disclosure can be used in an open circulating cooling water system, such as an open circulating cooling water system that includes one or more cooling towers that cool water via evaporative cooling.

The presently disclosed compositions are useful for inhibiting corrosion of metal surfaces in contact with any type of corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sodium sulfate, magnesium sulfate, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

In some embodiments, the medium is an aqueous medium with a pH of about 6 to about 14. For example, the aqueous medium may have a pH of about 7 to about 14, about 8 to about 14, about 9 to about 14, about 10 to about 14, about 11 to about 14, about 12 to about 14, about 13 to about 14, about 7 to about 13, about 8 to about 12, or about 9 to about 11.

The presently disclosed compositions are useful for inhibiting corrosion of surfaces comprising a variety of different metals. In some embodiments, the metal surface comprises steel, such as stainless steel, mild steel, or carbon steel. The metal surface may comprise, for example, copper, brass, and/or cupronickel.

In some embodiments, a pipe or a tank (e.g., railroad tank car or a tank truck/tanker) comprises the metal surface.

In some embodiments, the methods disclosed herein further comprise adding a component to the medium. The component may be added before, after, and/or with the composition. The component may be added continuously, automatically, intermittently, and/or manually. In some embodiments, the composition comprises the component. In some embodiments, the composition consists of or consists essentially of the reaction product, a solvent, and a component. The component may be any component and/or compound disclosed or contemplated herein other than the oxyanion of the amphoteric metal and the oxyanion of the amphoteric metal silicate.

The composition (and optional component if separate from the composition) may be added to the medium neat, dissolved in a solvent, partially dissolved in a solvent, and/or dispersed in a solvent. The addition may involve manual addition, automatic addition, dripping, pouring, spraying, pumping, injecting, or otherwise adding the composition and optional component to the medium and/or the metal surface. In some embodiments, the composition may be heated, such as from about 30° C. to 100° C., prior to addition. In some embodiments, the composition is added directly to the metal surface instead of or in addition to the medium.

In some embodiments, the medium and/or metal surface to be treated with the presently disclosed composition may be located in a cooling water system, a boiler water system, a petroleum well, a downhole formation, a geothermal well, a mineral washing process, a flotation and benefaction process, a papermaking process, a gas scrubber, an air washer, a continuous casting processes, an air conditioning and refrigeration process, a water reclamation process, a water purification process, a membrane filtration process, a clarifier, a municipal sewage treatment process, a municipal water treatment process, or a potable water system.

In certain embodiments, the compositions and methods disclosed herein can be used in textile care/laundry, in the paper industry for scale control and/or as a stabilizer/synergist for Zn, Mn, Sn, V, or Ti-based mild steel corrosion control in aqueous media, and/or in mining operations.

In certain aspects, an effective amount of the oxyanion of the amphoteric metal being added to the medium can range from about 0.1 ppm to about 400 ppm, such as from about 0.1 ppm to about 300 ppm, about 0.1 ppm to about 250 ppm, about 0.1 ppm to about 200 ppm, about 0.1 ppm to about 150 ppm, about 0.1 ppm to about 100 ppm, about 0.1 ppm to about 90 ppm, about 0.1 ppm to about 80 ppm, about 0.1 ppm to about 70 ppm, about 0.1 ppm to about 60 ppm, about 0.1 ppm to about 50 ppm, about 0.1 ppm to about 40 ppm, about 0.1 ppm to about 30 ppm, about 0.1 ppm to about 20 ppm, about 0.1 ppm to about 10 ppm, about 1 ppm to about 10 ppm, about 1 ppm to about 20 ppm, about 0.1 ppm to about 30 ppm, about 0.1 ppm to about 40 ppm, about 0.1 ppm to about 50 ppm, about 0.1 ppm, about 1 ppm, about 3 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, and/or about 100 ppm.

In certain aspects, an effective amount of the silicate, the silica, or the combination thereof added to the medium can range from about 0 ppm to about 200 ppm, about 0 ppm to about 150 ppm, about 0 ppm to about 100 ppm, about 0 ppm to about 50 ppm, about 0.1 ppm to about 200 ppm, about 0.1 ppm to about 100 ppm, about 0.1 ppm to about 90 ppm, about 0.1 ppm to about 80 ppm, about 0.1 ppm to about 70 ppm, about 0.1 ppm to about 60 ppm, about 0.1 ppm to about 50 ppm, about 1 ppm to about 200 ppm, about 5 ppm to about 200 ppm, about 10 ppm to about 200 ppm, about 20 ppm to about 200 ppm, about 40 ppm to about 200 ppm, about 60 ppm to about 200 ppm, about 80 ppm to about 200 ppm, or about 100 ppm to about 200 ppm.

In certain aspects, an effective amount of the oxyanion of the amphoteric metal silicate or oxyanionsilicate salt added to the medium can range from about 0 ppm to about 200 ppm, about 0 ppm to about 150 ppm, about 0 ppm to about 100 ppm, about 0 ppm to about 50 ppm, about 0.1 ppm to about 200 ppm, about 0.1 ppm to about 100 ppm, about 0.1 ppm to about 90 ppm, about 0.1 ppm to about 80 ppm, about 0.1 ppm to about 70 ppm, about 0.1 ppm to about 60 ppm, about 0.1 ppm to about 50 ppm, about 1 ppm to about 200 ppm, about 5 ppm to about 200 ppm, about 10 ppm to about 200 ppm, about 20 ppm to about 200 ppm, about 40 ppm to about 200 ppm, about 60 ppm to about 200 ppm, about 80 ppm to about 200 ppm, about 100 ppm to about 200 ppm, about 0.1 ppm, about 1 ppm, about 3 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, or about 100 ppm.

In some aspects, an amount of the stabilizer added to the medium can be from about 0 to about 200 ppm, such as from about 0 ppm to about 150 ppm, about 0 ppm to about 100 ppm, about 0 ppm to about 50 ppm, about 0.1 ppm to about 200 ppm, about 0.1 ppm to about 100 ppm, about 0.1 ppm to about 90 ppm, about 0.1 ppm to about 80 ppm, about 0.1 ppm to about 70 ppm, about 0.1 ppm to about 60 ppm, about 0.1 ppm to about 50 ppm, about 1 ppm to about 200 ppm, about 5 ppm to about 200 ppm, about 10 ppm to about 200 ppm, about 20 ppm to about 200 ppm, about 40 ppm to about 200 ppm, about 60 ppm to about 200 ppm, about 80 ppm to about 200 ppm, about 100 ppm to about 200 ppm, about 0.1 ppm, about 1 ppm, about 3 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, or about 100 ppm.

In certain aspects, an effective amount of the additional component added to the medium can range from about 0 ppm to about 5,000 ppm, such as from about 0.1 ppm to about 5,000 ppm, about 0.1 ppm to about 4,000 ppm, about 0.1 ppm to about 3,000 ppm, about 0.1 ppm to about 2,000 ppm, about 0.1 ppm to about 1,000 ppm, about 0.1 ppm to about 500 ppm, about 1 ppm to about 5,000 ppm, about 10 ppm to about 5,000 ppm, about 100 ppm to about 5,000 ppm, about 250 ppm to about 5,000 ppm, about 500 ppm to about 5,000 ppm, or about 1,000 ppm to about 5,000 ppm. In some aspects, the amount of the additional component added is about 0.1 ppm, about 1 ppm, about 5 ppm, about 15 ppm, about 25 ppm, about 35 ppm, about 45 ppm, about 55 ppm, about 65 ppm, about 75 ppm, about 85 ppm, about 95 ppm, about 125 ppm, about 150 ppm, about 175 ppm, about 200 ppm, about 300 ppm, about 400 ppm, about 500 ppm, about 750 ppm, about 1,000 ppm, about 1,500 ppm, about 2,000 ppm, about 2,500 ppm, or about 3,000 ppm.

The corrosion inhibitor composition can be used in a variety of concentration levels in the medium, such as at a concentration from about 0.1 ppm to about 10,000 ppm, about 0.1 ppm to about 8,000 ppm, about 0.1 ppm to about 6,000 ppm, about 0.1 ppm to about 4,000 ppm, about 0.1 ppm to about 2,000 ppm, about 0.1 ppm to about 1,000 ppm, about 0.1 ppm to about 500 ppm, about 0.1 ppm to about 100 ppm, about 5 ppm to about 100 ppm, about 5 ppm to about 500 ppm, or about 5 ppm to about 1,000 ppm. In some aspects, the concentration of the corrosion inhibitor composition in the medium can be about 0.1 ppm, about 0.5 ppm, about 1 ppm, about 10 ppm, about 25 ppm, about 50 ppm, about 75 ppm, about 100 ppm, about 200 ppm, about 300 ppm, about 400 ppm, about 500 ppm, about 750 ppm, about 1,000 ppm, about 2,000 ppm, about 3,000 ppm, about 4,000 ppm, about 5,000 ppm, about 7,500 ppm, or about 10,000 ppm.

The corrosion inhibitor compositions disclosed herein are effective regardless of the level of corrodent in the medium. In some embodiments, the corrodent may be present in an amount of at least about 10 ppm, at least about 50 ppm, at least about 100 ppm, at least about 300 ppm, at least about 500 ppm, at least about 1,000 ppm, at least about 2,000 ppm, at least about 5,000 ppm, at least about 10,000 ppm, at least about 20,000 ppm, or less than about 100,000 ppm.

As can be seen in the examples that follow, the present inventors have discovered a synergistic combination of components that inhibit or prevent pitting, as well as other types of corrosion. In certain aspects, the synergy is between a mixture of an oxyanion of an amphoteric material, a silicate, and saccharic acid, and/or salts thereof and/or derivatives thereof. Thus, in one aspect, where pitting corrosion is involved, a corrosion inhibitor composition according to the present disclosure can comprise a mixture of an oxyanion of an amphoteric material, such as sodium stannite, with sodium silicate, and saccharic acid, and/or salts thereof and/or derivatives thereof.

The presently disclosed corrosion inhibitor compositions can be added into the systems by any means known in the art. For example, the inhibitor can be injected via a chemical metering pump into the system. Other acceptable methods of injection include pretreating/precoating the metal surfaces before exposure to the corrosive media, continuous injection, or batch treating. Continuous addition/injection may be performed where appropriate chemical injection equipment is available in the field along with chemical storage tanks. Otherwise, the chemical may be treated using a specialized treatment vehicle, which applies a large chemical dosage at long time intervals, usually every one to two weeks, and in certain cases, monthly. Batch application may be performed through the use of a treating truck comprising a storage tank containing the corrosion inhibitor(s) (and optionally other chemicals) and a large water tank. The treating truck travels to field locations and treats individual sites.

The foregoing may be better understood by reference to the following examples, which are intended for illustrative purposes and are not intended to limit the scope of the disclosure or its application in any way.

### Examples

Reference is made in the following to a number of illustrative examples of the compositions and methods disclosed herein. The following embodiments should be considered as only an illustration of such methods and compositions and should not be considered to be limiting in any way.

In a first example, about 200 ppm of a stannite solution was added as a corrosion inhibitor to river water. A mild steel coupon was immersed in the river water, agitated, and brought to about 40° C. for about 50 hours. A similar procedure was followed for a second trial but the corrosion inhibitor was not added. Upon comparing the two coupons after the experiments were conducted, the coupon that was contacted by the corrosion inhibitor was shiny and significantly less corroded than the coupon that was not in contact with a corrosion inhibitor.

A similar experiment was conducted but this time the corrosion inhibitor composition included sodium stannisilicate along with saccharic acid. After about 50 hours, the untreated coupon was highly corroded but the coupon treated with the corrosion inhibitor composition was shiny with minimal signs of corrosion.

Similar experiments were conducted with corrosion inhibitor compositions containing the amphoteric metals (and other optional components) listed in Table 1.

TABLE 1

| | Ampho- | | Perfor- | |
|---|---|---|---|---|
| Test | teric | | mance | Corrosion |
| ID# | metal | Treatment composition | rating | rate / mpy |
| 1 | N/A | Blank (with no treatment) | 0 | NA |
| 2 | Sn(II) | sodium stannite + Saccharate + | 5 | NA |
| | | Silicate | | |
| 3 | Fe(II) | sodium ferrite + saccharate + | 3 | NA |
| | | silicate | | |
| 4 | Sn(IV) | sodium stannate + saccharate + | 4 | NA |
| | | silicate | | |
| 5 | Al(III) | sodium aluminate + saccharate + | 5 | NA |
| | | silicate | | |
| 6 | N/A | saccharte + silicate | 2 | NA |
| 7 | Zn(II) | sodium zincate + saccharate + | 5 | NA |
| | | silicate | | |
| 8 | Fe(III) | sodium ferrate + saccharate + | 1 | NA |
| | | silicate | | |
| 9 | N/A | Blank | 0 | NA |
| 10 | Zn(II) | Sodium/potassium zincate + | 5 | NA |
| | | saccharate + silicate | | |
| 11 | Zn(II) | Sodium zincate + silicate | 3 | NA |
| 12 | Zn(II) | Sodium zincate + saccharate | 4 | NA |
| 13 | N/A | Saccharate + silicate | 2 | NA |
| 14 | N/A | Blank | 0 | NA |
| 15 | Zr(IV) | Sodium zirconate + saccharate + | 4 | NA |
| | | silicate | | |
| 16 | Ti(IV) | Titanate + saccharate | 3 | NA |
| 17 | Ti(IV) | Sodium/potassium titanate + | 4 | NA |
| | | saccharate + silicate | | |
| 18 | Ti(III) | Sodium tinanite + saccharate + | 5 | NA |
| | | silicate | | |
| 19 | Al(III) | Sodium aluminate + Polyglycerol | 4 | 1.38mpy |
| | | (MW = 320) | | |
| 20 | Al(III) | Sodium aluminate + Polyglycerol | 4 | 1.33mpy |
| | | (MW = 4100) | | |
| 21 | Al(III) | Sodium aluminate + Triglycerol | 4 | 0.58mpy |
| 22 | Al(III) | Sodium aluminate + Hexaglycerol | 4 | 0.58mpy |
| 23 | Al(III) | Sodium aluminate + Oxalate | 4 | 1.24mpy |
| 24 | Al(III) | Sodium aluminate + tartarate | 4 | 0.54mpy |
| 25 | Al(III) | Sodium aluminate + 15% | 4 | 0.47mpy |
| | | carboxymethylated polyglycerol | | |
| 26 | Al(III) | Sodium aluminate + | 4 | 0.57mpy |
| | | hydroxycarboxylated sorbitol | | |
| 27 | Al(III) | Sodium aluminate + | 5 | 0.31mpy |
| | | pentaerythritol ethoxylated (MW = | | |
| | | 270, EO = 3) | | |
| 28 | Al(III) | Sodium aluminate + triethylene | 4 | 0.50mpy |
| | | glycol (MW = 192) | | |

NA = not
0 = Badly corroded avaliable
1 = corroded
2 = many corrosion spots
3 = some corrosion spots
4 = corrosion at edges or minor corrosion
5 = Shinny with no corrosion
N/A = not applicable

Additional testing confirmed that the presently disclosed oxyanions of amphoteric metals (and metal silicates), such as a stannasilicate, stannisilicate, etc., optionally combined with a hydroxycarboxylic acid (e.g., saccharic acid or tartaric acid), or wherein a hydroxycarboxylic acid is added separately to the medium, can effectively prevent corrosion in both soft water and hard water, which contains high levels of calcium and alkalinity.

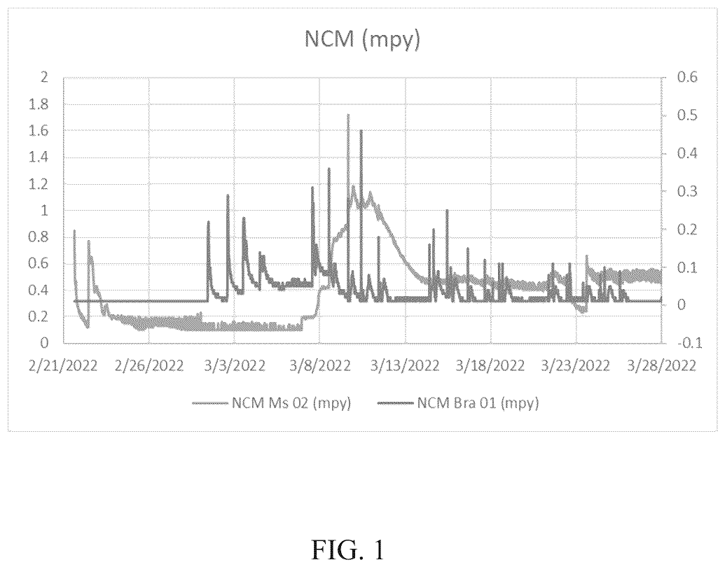

FIG. 1 shows corrosion rate data from a pilot cooling tower test using the combination of stannisilicate and saccharic acid. The pilot cooling tower underwent testing for over a month at a pH level of about 8 in soft water, and the mild steel tubes in contact with the medium remained shiny throughout the time period with very minimal signs of corrosion. As can be seen, the corrosion rate for mild steel (Ms) was measured at about 0.4 to 0.6 mpy, and for brass (Br) was measured at less than about 0.1.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a stabilizer” is intended to include “at least one stabilizer” or “one or more stabilizers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface in contact with a medium, comprising:
adding a composition to the medium, wherein the composition comprises an oxyanion of an amphoteric metal.

2. The method of claim 1, wherein the amphoteric metal is selected from the group consisting of zinc, aluminum, tin, iron, titanium, zirconium, copper, and any combination thereof.

3. The method of claim 1, wherein the oxyanion of the amphoteric metal is selected from the group consisting of sodium zincate, sodium stannite, sodium stannate, sodium aluminate, sodium titanate, sodium titanite, sodium zirconate, sodium cuprate, sodium ferrite, sodium ferrate, potassium zincate, potassium stannite, potassium stannate, potassium aluminate, potassium titanate, potassium titanite, potassium zirconate, potassium cuprate, potassium ferrite, potassium ferrate, lithium zincate, lithium stannite, lithium stannate, lithium aluminate, lithium titanate, lithium titanite, lithium zirconate, lithium cuprate, lithium ferrite, lithium ferrate, and any combination thereof.

4. The method of claim 1, further comprising adding a silicate, a silica, or a combination thereof to the medium.

5. The method of claim 4, wherein the silicate, the silica, and/or the combination thereof is added before, after, and/or with the oxyanion of the amphoteric metal.

6. The method of claim 4, further comprising reacting the silicate, the silica, and/or the combination thereof with the oxyanion of the amphoteric metal and forming an oxyanion of an amphoteric metal silicate.

7. The method of claim 6, wherein the oxyanion of the amphoteric metal silicate is selected from the group consisting of a sodium aluminosilicate salt, a sodium zincnosilicate salt, a sodium stannasilicate salt, a sodium stannisilicate salt, a sodium titanisilicate salt, a sodium titanosilicate salt, a sodium zirconosilicate salt, a sodium cuprate silicate salt, a sodium ferrisilicate salt, a sodium ferrasilicate salt, a potassium aluminosilicate salt, a potassium zincnosilicate salt, a potassium stannasilicate salt, a potassium stannisilicate salt, a potassium titanisilicate salt, a potassium titanosilicate salt, a potassium zirconosilicate salt, a potassium cuprate silicate salt, a potassium ferrisilicate salt, a potassium ferrasilicate salt, a lithium aluminosilicate salt, a lithium zincnosilicate salt, a lithium stannasilicate salt, a lithium stannisilicate salt, a lithium titanisilicate salt, a lithium titanosilicate salt, a lithium zirconosilicate salt, a lithium cuprate silicate salt, a lithium ferrisilicate salt, a lithium ferrasilicate salt, and any combination thereof.

8. The method of claim 1, further comprising adding from about 0.1 ppm to about 400 ppm of the oxyanion of the amphoteric metal to the medium.

9. The method of claim 4, further comprising adding from about 0.1 ppm to about 200 ppm of the silicate, the silica, or the combination thereof to the medium.

10. The method of claim 6, further comprising adding from about 0.1 ppm to about 400 ppm of the oxyanion of the amphoteric metal silicate to the medium.

11. The method of claim 1, further comprising adding an additional component to the medium, wherein the additional component is selected from the group consisting of a fouling control agent, an additional corrosion inhibitor, a biocide, a preservative, an acid, a hydrogen sulfide scavenger, a surfactant, a scale inhibitor, a pH modifier, a coagulant/flocculant agent, a water clarifier, a dispersing agent, an antioxidant, a polymer degradation prevention agent, a permeability modifier, a CO₂ scavenger, an O₂ scavenger, a gelling agent, a lubricant, a friction reducing agent, a salt, a stabilizer, a yellow metal corrosion inhibitor, and any combination thereof.

12. The method of claim 11, wherein the stabilizer comprises a hydroxycarboxylic acid.

13. The method of claim 1, wherein the method excludes adding a phosphate to the medium.

14. A composition, comprising:
a zincate, a stannite, a stannate, or any combination thereof;
a silicate; and
a hydroxycarboxylic acid.

15. The composition of claim 14, further comprising from about 0.01 wt. % to about 99 wt. % of the zincate, stannite, stannate, or combination thereof; from about 0.1 wt. % to about 30 wt. % of the silicate; and from about 0 wt. % to about 50 wt. % of the hydroxycarboxylic acid.

16. The composition of claim 14, wherein the composition comprises sodium stannite, sodium silicate, and saccharic acid.

17. The composition of claim 14, further comprising a solvent.

18. The composition of claim 14, wherein the composition comprises a pH of about 6 to about 14.

19. The composition of claim 14, wherein the composition excludes phosphorous.
